(19) United States
(12) Patent Application Publication
(10) Pub. No.: US 2006/0088675 A1
(43) Pub. Date: Apr. 27, 2006

(54) Radiation curable inkjet coatings for media and systems for processing the media

(76) Inventors: Molly I. Hladik, San Diego, CA (US); Silke Courtenay, Temecula, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/047,029

(22) Filed: Jan. 31, 2005

Related U.S. Application Data
(63) Continuation of application No. 60/621,934, filed on Oct. 25, 2004.

(51) Int. Cl. B41M 5/40

(52) U.S. Cl. 428/32.38

(57) ABSTRACT

Methods of preparing a print media and systems for preparing an ink-jet image, are disclosed. One exemplary method, among others, includes providing a print substrate; dispensing a monomer/oligomer composition onto the print substrate, wherein the monomer/oligomer composition includes at least one monomer/oligomer and a photointiator; and exposing the monomer/oligomer composition to a radiation energy, wherein the interaction of the radiation energy with the photoinitiator initiates the polymerization of the first monomer/oligomer and the second monomer/oligomer in the monomer/oligomer composition to form an ink receiving layer.

### CROSS-REFERENCE TO RELATED APPLICATION

This application claims priority to copending U.S. provisional patent application entitled “Radiation Curable Inkjet Coatings for Media and Systems for Processing the Media” filed on Oct. 25, 2004 and accorded Ser. No. 60/621,934, which is entirely incorporated herein by reference.

### BACKGROUND

Currently used methods of producing print media generate a large amount of waste because large amounts of water and/or solvent are used in the process. In addition, since large amounts of water and/or solvent are used, the time needed to dry (e.g., dry time) the print media is relatively long and expends much energy. Therefore, there is a need in the industry for a process for producing print media that uses less solvent and decreases dry time.

### SUMMARY

Briefly described, embodiments of this disclosure include methods of preparing a print media and systems for preparing an ink-jet image. One exemplary embodiment of the method, among others, includes: providing a print substrate; dispensing a monomer/oligomer composition onto the print substrate, wherein the monomer/oligomer composition includes at least one monomer/oligomer and a photointiator; and exposing the monomer/oligomer composition to a radiation energy, wherein the interaction of the radiation energy with the photointiator initiates the polymerization of the monomer/oligomer composition to form an ink receiving layer.

One exemplary embodiment of the system for preparing an ink-jet printing medium, among others, includes: a print medium and a radiation system. The print medium includes: a print substrate, a monomer/oligomer composition disposed on the print substrate, wherein the monomer/oligomer composition includes at least one monomer/oligomer and a photoinitiator. The radiation system is configured to irradiate energy at the monomer/oligomer composition, where the polymerization is initiated upon exposure of the monomer/oligomer composition to the radiation energy.

### BRIEF DESCRIPTION OF THE DRAWINGS

Many aspects of this disclosure can be better understood with reference to the following drawings. The components in the drawings are not necessarily to scale. Moreover, in the drawings, like reference numerals designate corresponding parts throughout the several views.

FIG. 1 illustrates an embodiment of a media processing system.

FIG. 2 illustrates a flow diagram of a representative embodiment for processing print media.

### DETAILED DESCRIPTION

Radiation curable inkjet coatings for print media and systems for processing the print media are provided. In general, a monomer/oligomer composition is disposed on a print substrate. The monomer/oligomer composition includes one or more monomers and/or oligomers and a photoinitiator. Once disposed onto the print substrate, the monomer/oligomer composition is irradiated with energy (e.g., ultra violet energy) to promote polymerization of the monomers and/or oligomers to form an ink-receiving layer that is printable after polymerization is complete. Use of the radiation curable inkjet coating decreases the amount of waste produced by having a reduced amount or eliminating the water or solvent in the coating and/or decreases the time to dry the media.

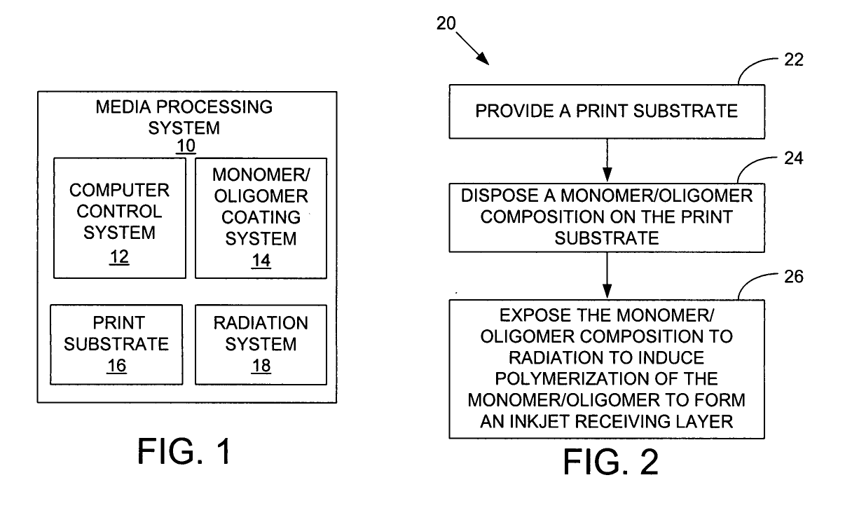

FIG. 1 illustrates a representative embodiment of a media processing system 10. The media processing system 10 can include, but is not limited to, a computer control system 12, a monomer/oligomer coating system 14, a print substrate 16, and an radiation system 18. The computer control system 12 is operative to control the dispensing of a monomer/oligomer composition (“/” denotes and/or) on the print substrate 16 using the monomer/oligomer coating system 14. In addition, the computer control system 12 is operative to initiate the polymerization of the monomer/oligomer composition by controlling the radiation system 18. In this regard, the radiation system 18 irradiates the monomer/oligomer composition dispensed on the print substrate 16.

The radiation system 18 can include, but is not limited to, a laser system, ultraviolet (UV) energy system, infrared (IR) energy system, visible energy system, x-ray system, and other systems that can promote the polymerization of the monomer/oligomer composition. The radiation energy can include, but is not limited to, IR energy, UV energy, x-ray energy, and visible light energy.

The monomer/oligomer coating system 14 is configured to store and dispense the monomer/oligomer composition onto the print substrate 16. The monomer/oligomer coating system 14 can include one or more compartments that store the components of the monomer/oligomer composition until the components are dispensed. In general, the components of the monomer/oligomer composition are premixed and dispensed onto the print substrate 16 as a mixture. The monomer/oligomer coating system 14 can include, but is not limited to, curtain coating systems, slot coating systems, rod coating systems, gravure coating system, blade coating systems, combinations thereof, as well as other coating systems used in the preparation of print media.

In general, the monomer/oligomer composition includes, but is not limited to, one or more monomers and/or oligomers and a photointiator. The radiation activated polymerization mechanism includes the interaction of the photoinitiator with radiation energy (e.g., ultraviolet and/or visible light energy) from the radiation system 18. Interaction of the light energy with the photoinitiator causes the photoinitiator to form an initiation species (e.g., cationic initiators, radical initiators, and the like). The initiator promotes the polymerization of the one or more monomers and/or oligomers to produce their polymeric forms.

FIG. 2 is a flow diagram describing a representative method 20 for fabricating print media using the media processing system 10. In block 22, a print substrate 16 is provided. The print substrate 16 can include, but is not limited to, a paper medium, a photobase medium, a plastic medium such as clear to opaque plastic film, and the like. The print substrate 16 may include, but is not limited to, a hard or flexible material made from a polymer material, a paper material, a glass material, a ceramic material, a woven cloth material, a non-woven cloth material, and combinations thereof. The print substrate 16 may be from about 2 mils to about 12 mils thick, depending on a desired end application for the print medium.

In block 24, the monomer/oligomer composition is disposed onto the print substrate 16 using the monomer/oligomer coating system 14. In block 26, the monomer/oligomer composition is exposed to radiation (e.g., ultraviolet energy) using the radiation system 18, which promotes the polymerization of the monomer/oligomer composition and forms an ink-receiving layer. Additional processing can be performed after the ink-receiving layer is formed. It should be noted that using the monomer/oligomer composition and radiation can reduce the amount of dry time needed to process the print medium and/or reduce the amount of waste produced since less water and/or solvent is used in the monomer/oligomer composition.

In the following description of the monomer/oligomer composition, oligomers can include compounds having from 2 to 20 monomer units of one or more types of monomers. Also, the following description lists various monomer units and it should be understood the oligomers of these monomers, individually or in combination, can also be included in the monomer/oligomer composition.

The monomer/oligomer composition can include monomers and/or oligomers such as, but not limited to, monomers and/or oligomers having a hydrophilic and/or a polar group (e.g., a hydroxy group, an ether group, an ethyl ether group, a propyl ether group, isocyante, n-vinyl pyrrolidone (NVP), n-vinyl caprolactam, vinyl imidazole, and combinations thereof), monomers and/or oligomers having a cationic charge such as, but not limited to, N,N-dimethylaminoethyl acrylate methyl chloride, N,N-dimethylaminoethyl methacrylate methyl chloride, and combinations thereof.

The monomers and/or oligomers having the hydrophilic group can include, but are not limited to, acrylates, vinyl ethers, unsaturated esters and ring opening monomers such as epoxies and oxetanes.

In an embodiment, the monomer/oligomer composition includes monomers and/or oligomers having a hydrophilic/polar group. The polymerization of one or more of the monomers and/or oligomers forms a polymer having the hydrophilic/polar group.

The monomers and/or oligomers can be about 30% to 99% by weight of the monomer/oligomer composition, about 60% to 99% by weight of the monomer/oligomer composition, and about 80% to 99% by weight of the monomer/oligomer composition.

The photoinitiator and in some embodiments a photoinitiator system including multiple components can include, but is not limited to, UV initiators and/or visible initiators. The UV initiator can include chemicals such as, but not limited to, a free radical initiator, a cationic initiator, or combinations thereof. The free-radical initiator includes compounds that produce a free radical on exposure to UV radiation. The free-radical is capable of initiating a polymerization reaction among the monomers and/or oligomers present in the monomer/oligomer composition.

Examples of free-radical initiators include, but are not limited to, benzophenones (e.g., benzophenone, methyl benzophenone, Michler's ketone, and xanthones), acylphosphine oxide type free radical initiators (e.g., 2,4,6-trimethylbenzoyidiphenyl phosphine oxide (TMPO), 2,4,6-trimethylbenzoylethoxyphenyl phosphine oxide (TEPO), and bisacylphosphine oxides (BAPO's)), azo compounds (e.g., AIBN), benzoins, and benzoin alkyl ethers (e.g., benzoin, benzoin methyl ether and benzoin isopropyl ether).

In addition, the free radical photoinitiator can include, but is not limited to: acyloin; a derivative of acyloin, such as benzoin ethyl ether, benzoin isobutyl ether, desyl bromide, and α-methylbenzoin; a diketone, such as benzil and diacetyl; an organic sulfide, such as diphenyl monosulfide, diphenyl disulfide, desyl phenyl sulfide, and tetramethylthiuram monosulfide; a thioxanthone; an S-acyl dithiocarbamate, such as S-benzoyl-N,N-dimethyldithiocarbamate and S-(p-chlorobenzoyl)-N,N-dimethyldithiocarbamate; a phenone, such as acetophenone, α-α-α-tribromoacetophenone, o-nitro-α-α-α-tribromoacetophenone, benzophenone, and p,p′-tetramethyldiaminobenzophenone; a quinone; a triazole; a sulfonyl halide, such as p-toluenesulfonyl chloride; a phosphorus-containing photoinitiator, such as an acylphosphine oxide; an acrylated amine; or mixtures thereof.

The free-radical initiator can be used alone or in combination with a co-initiator. Co-initiators are used with initiators that need a second molecule to produce a radical that is active in UV-systems. For example, benzophenone uses a second molecule, such as an amine, to produce a reactive radical. A preferred class of co-initiators are alkanolamines such as, but not limited to, triethylamine, methyldiethanolamine, and triethanolamine

Suitable cationic initiators include, but are not limited to, compounds that form aprotic acids or Brønsted acids upon exposure to UV light sufficient to initiate polymerization. The cationic initiator used may be a single compound, a mixture of two or more active compounds, or a combination of two or more different compounds (e.g., co-initiators).

The cationic photoinitiator can include, but is not limited to, onium salt, such as a sulfonium salt, an iodonium salt, or mixtures thereof. In addition, the cationic photoinitiatior can include, but is not limited to, an aryldiazonium salt, a bis-diaryliodonium salt, a diaryliodonium salt of sulfonic acid, a triarylsulfonium salt of sulfonic acid, a diaryliodonium salt of boric acid, a diaryliodonium salt of boronic acid, a triarylsulfonium salt of boric acid, a triarylsulfonium salt of boronic acid, or mixtures thereof. Examples of cationic photoinitiatiors include, but are not limited to, diaryliodonium hexafluoroantimonate, aryl sulfonium hexafluorophosphate, aryl sulfonium hexafluoroantimonate, bis(dodecyl phenyl) iodonium hexafluoroarsenate, tolyl-cumyliodonium tetrakis(pentafluorophenyl) borate, bis(dodecylphenyl) iodonium hexafluoroantimonate, dialkylphenyl iodonium hexafluoroantimonate, diaryliodonium salts of perfluoroalkylsulfonic acids (such as diaryliodonium salts of perfluorobutanesulfonic acid, perfluoroethanesulfonic acid, perfluorooctanesulfonic acid, and trifluoromethane sulfonic acid), diaryliodonium salts of aryl sulfonic acids (such as diaryliodonium salts of para-toluene sulfonic acid, dodecylbenzene sulfonic acid, benzene sulfonic acid, and 3-nitrobenzene sulfonic acid), triarylsulfonium salts of perfluoroalkylsulfonic acids (such as triarylsulfonium salts of perfluorobutanesulfonic acid, perfluoroethanesulfonic acid, perfluorooctanesulfonic acid, and trifluoromethane sulfonic acid), triarylsulfonium salts of aryl sulfonic acids (such as triarylsulfonium salts of para-toluene sulfonic acid, dodecylbenzene sulfonic acid, benzene sulfonic acid, and 3-nitrobenzene sulfonic acid), diaryliodonium salts of perhaloarylboronic acids, triarylsulfonium salts of perhaloarylboronic acid, or mixtures thereof.

The visible radiation initiator can include, but is not limited to, diketones (e.g., camphorquinone, 1,2-acenaphthylenedione, 1H-indole-2,3-dione, 5H-dibenzo[a,d]cycloheptene-10, and 1′-dione), phenoxazine dyes (e.g., Resazurin, Resorufin), acylphosphine oxides, (e.g., diphenyl (2,4,6-trimethylbenzoyl) phosphine oxide), and the like.

The photoinitiator and photoinitiator system can be about 0.01% to 10% by weight of the monomer/oligomer composition.

As mentioned above, the monomer/oligomer composition includes one or more monomers and/or oligomers and a photoinitiator. An exemplary monomer/oligomer composition includes about 3% photoinitiator and about about 97% hydroxylethyl acrylate. In another embodiment of the monomer/oligomer composition, the composition includes about 3% photoinitiatior, about 35% NVP, about 35% hydroxylpropyl acrylate, about 16% silica, and about 10% N,N-dimethylaminoethyl acrylate methyl chloride. In another embodiment of the monomer/oligomer composition, the composition includes about 75% hyrdoxy elthyl acrylate, about 10% PEG 400 diacrylate, about 10% N,N-dimethylaminoethyl acrylate methyl chloride, and about 5% photoinitiator.

As mentioned above, the polymerization of the monomers and oligomers forms the ink-receiving layer. The ink-receiving layer has a thickness of about 3 grams per square meter (GSM) to 40 GSM.

In traditional systems the amount of water in the coatings formulation is from about 20 to 90% water. In this embodiment of this disclosure the amount of water can be greatly reduced to include at most 30%, at most 20%, at most 15%, to at most 10%, to at most 5%, or substantially eliminate (e.g., less than 5%, less than 3%, and less than 1%) the amount of water as compared to what is normally needed to coat inkjet coatings. This allows coating on a more diverse set of equipment without the worry of drying the coating before it goes into the master roll.

In addition, the monomer/oligomer composition can include other additives such as, but not limited to, mordants, microporous and/or mesoporous inorganic particles, and fillers. The additive is about 0% to 70% by weight of the monomer/oligomer composition, 0% to 40% by weight of the monomer/oligomer composition, and 0% to 20% by weight of the monomer/oligomer composition. In monomer/oligomer compositions including one or more additives, the additive is about 0.01% to 70% by weight of the monomer/oligomer composition, 0.01% to 40% by weight of the monomer/oligomer composition, and 0.01% to 20% by weight of the monomer/oligomer composition.

The mordant chemically interacts (e.g., ionically bonds) with the dye-based ink. In particular, cationic mordant ionically bonds with anionic dye-based ink. The mordant may be a cationic polymer such as, but not limited to, a polymer having a primary amino group, a secondary amino group, a tertiary amino group, a quaternary ammonium salt group, or a quaternary phosphonium salt group. The mordant may be in a water-soluble form or in a water-dispersible form, such as in latex.

The water-soluble cationic polymer can include, but is not limited to, a polyethyleneimine; a polyallylamine; a polyvinylamine; a dicyandiamide-polyalkylenepolyamine condensate; a polyalkylenepolyamine-dicyandiamideammonium condensate; a dicyandiamide-formalin condensate; an addition polymer of epichlorohydrin-dialkylamine; a polymer of diallyldimethylammoniumchloride (“DADMAC”); a copolymer of diallyldimethylammoniumchloride-SO₂, polyvinylimidazole, polyvinylpyrrolidone; a copolymer of vinylimidazole, polyamidine, chitosan, cationized starch, polymers of vinylbenzyltrimethylqammoniumchloride, (2-methacryloyloxyethyl)trimethyl-ammoniumchloride, and polymers of dimethylaminoethylmethacrylate; or a polyvinylalcohol with a pendant quaternary ammonium salt. Examples of the water-soluble cationic polymers that are available in latex form and are suitable as mordants include, but are not limited to, TruDot P-2604, P-2606, P-2608, P-2610, P-2630, and P-2850 (available from MeadWestvaco Corp. (Stamford, Conn.)) and Rhoplex® Primal-26 (available from Rohm and Haas Co. (Philadelphia, Pa.)), WC-71 and WC-99 from PPG (Pittsburgh, Pa.), and Viviprint 200 and Viviprint 131 (available from ISP. (Wayne, N.J.)).

A metal salt may also be used as the mordant and can include, but is not limited to, a salt of an organic or inorganic acid, an organic metal compound, and a metal complex. In one embodiment, an aluminum salt may be used since aluminum salts are inexpensive and provide the desired properties in the ink-receiving layer. The aluminum salt can include, but is not limited to, aluminum fluoride, hexafluoroaluminate (e.g., potassium salts), aluminum chloride, basic aluminum chloride (e.g., polyaluminum chloride), tetrachloroaluminate (e.g., sodium salts thereof), aluminum bromide, tetrabromoaluminate (e.g., potassium salts thereof), aluminum iodide, aluminate (e.g., sodium salts, potassium salts, and calcium salts thereof), aluminum chlorate, aluminum perchlorate, aluminum thiocyanate, aluminum sulfate, basic aluminum sulfate, aluminum sulfate potassium (alum), ammonium aluminum sulfate (ammonium alum), sodium sulfate aluminum, aluminum phosphate, aluminum nitrate, aluminum hydrogenphosphate, aluminum carbonate, polyaluminum sulfate silicate, aluminum formate, aluminum diformate, aluminum triformate, aluminum acetate, aluminum lactate, aluminum oxalate, aluminum isopropionate, aluminum butyrate, ethyl acetate aluminum diisopropionate, aluminum tris(acrylacetonate), aluminum tris(ethylacetoacetate), and aluminum monoacetylacetonate-bis(ethylaceto-acetate). Preferably, the mordant is a quaternary ammonium salt such as, but not limited to, a DADMAC derivative; an aluminum salt (e.g., aluminum triformate or aluminum chloride hydrate; and a cationic latex that includes quaternary ammonium functional groups (e.g., TruDot P-2608). These chemicals are available from numerous sources, such as BASF Corp. (Mount Olive, N.J.), Ciba Specialty Chemicals (Basel, Switzerland), and MeadWestvaco Corp. (Stamford, Conn.).

Typically, the microporous and/or mesoporous inorganic particles have a large surface area. The microporous and/or mesoporous inorganic particles may be bound in a polymer in the ink-receiving layer. The microporous and/or mesoporous inorganic particles may include, but are not limited to, silica, silica-magnesia, silicic acid, sodium silicate, magnesium silicate, calcium silicate, alumina, alumina hydrate, barium sulfate, calcium sulfate, calcium carbonate, magnesium carbonate, magnesium oxide, kaolin, talc, titania, titanium oxide, zinc oxide, tin oxide, zinc carbonate, pseudo-boehmite, bentonite, hectorite, clay, and mixtures thereof.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range.

Many variations and modifications may be made to the above-described embodiments. All such modifications and variations are intended to be included herein within the scope of this disclosure and protected by the following claims.

At least the following is claimed:

1. A method of preparing a print media, comprising:
providing a print substrate;
dispensing a monomer/oligomer composition onto the print substrate, wherein the monomer/oligomer composition includes at least one monomer/oligomer and a photoinitiator; and
exposing the monomer/oligomer composition to a radiation energy, wherein the interaction of the radiation energy with the photoinitiator initiates the polymerization of the monomer/oligomer composition to form an ink receiving layer.

2. The method of claim 1, wherein the monomer/oligomer is a first monomer/oligomer and is selected from monomers/oligomers having a hydrophilic/polar group, monomers/oligomers having a cationic charge, and combinations thereof.

3. The method of claim 2, wherein the monomer/oligomer includes a second monomer/oligomer which is selected from monomers/oligomers having a hydrophilic/polar group, monomers/oligomers having a cationic charge, and combinations thereof, wherein the first monomer/oligomer and the second monomer/oligomer are not the same monomer/oligomer.

4. The method of claim 1, wherein the photoinitiator is selected from ultraviolet initiators, visible initiators, and combinations thereof.

5. The method of claim 1, wherein the monomer/oligomer composition includes a first monomer/oligomer having a hydrophilic/polar group, and a second monomer/oligomer having a hydrophilic/polar group; wherein the first monomer/oligomer and the second monomer/oligomer are not the same monomer/oligomer; and wherein the photoinitiator is an ultraviolet initiator.

6. The method of claim 1, wherein the radiation energy is selected from ultraviolet radiation energy, visible radiation energy, and combinations thereof.

7. The method of claim 1, wherein the monomer/oligomer composition includes an additive.

8. The method of claim 7, wherein the monomer/oligomer is about 30% to 99% by weight of the monomer/oligomer composition and wherein the photoinitiator is about 0.01% to 10% by weight of the monomer/oligomer composition, and wherein the additive is about 0.01% to 70% by weight of the monomer/oligomer composition.

9. The method of claim 1, wherein the print substrate is selected from a paper medium, a photobase medium, a plastic medium, a polymer material, a paper material, a glass material, a ceramic material, a woven cloth material, a non-woven cloth material, and combinations thereof.

10. The method of claim 1, wherein the monomer/oligomer includes at least one monomer/oligomer having a hydrophilic/polar group; wherein the photoinitiator is an ultraviolet initiator; wherein the monomer/oligomer is about 60% to 99% by weight of the monomer/oligomer composition; and wherein the photoinitiator is about 0.01% to 10% by weight of the monomer/oligomer composition.

11. A system for preparing a printing medium, comprising:
a print medium including:
a print substrate,
a monomer/oligomer composition disposed on the print substrate, wherein the monomer/oligomer composition includes at least one monomer/oligomer, and a photoinitiator; and
a radiation system configured to radiate energy at the monomer/oligomer composition, wherein the polymerization is initiated upon exposure of the monomer/oligomer composition to the radiation energy.

12. The system of claim 11, further comprising:
a monomer/oligomer dispensing system configured to dispense the monomer/oligomer composition onto the print substrate.

13. The system of claim 11, wherein the radiation system is an ultraviolet radiation system configured to irradiate ultraviolet radiation energy at the monomer/oligomer composition.

14. The system of claim 11, wherein the monomer/oligomer is selected from monomers/oligomers having a hydrophilic/polar group, and wherein the photoinitiator is an ultraviolet initiator.

15. The system of claim 11, wherein the irradiation energy is selected from ultraviolet radiation energy, visible radiation energy, and combinations thereof.
